(19) United States
(12) Patent Application Publication
(10) Pub. No.: US 2013/0339128 A1
(43) Pub. Date: Dec. 19, 2013

(54) PROMOTION SYSTEM, COMPUTER PROGRAM PRODUCT, AND RELATED METHOD

(71) Applicant: Move That Block LLC, Loudonville, NY (US)

(72) Inventors: Todd James Drowlette, Glenmont, NY (US); Patrick Shaun Gray, Delmar, NY (US)

(21) Appl. No.: 13/920,463

(22) Filed: Jun. 18, 2013

Related U.S. Application Data
(60) Provisional application No. 61/661,570, filed on Jun. 19, 2012.

(51) Int. Cl. G06Q 30/02

(52) U.S. Cl. CPC G06Q 30/0246
USPC 705/14.43; 705/14.45

(57) ABSTRACT

Promotion systems and related methods are disclosed. In one embodiment, a system includes: at least one computing device configured to manage a promotion for an organization by performing actions including: providing the promotion to a user, the promotion including: an enticement to purchase a product or a service at a local location of the organization; and a unique identifier for the user and the promotion; tracking whether the user utilizes the promotion to purchase the product or the service at the local location; and providing data about the purchase of the product or the service to the organization in response to the user executing the purchase, the data about the purchase of the product including data about the promotion, data about the user, and data about the local location.

### CROSS-REFERENCE TO RELATED APPLICATION

This application claims the benefit of U.S. Provisional Application No. 61/661,570 filed on Jun. 19, 2012, which is hereby incorporated by reference in its entirety.

### FIELD OF THE INVENTION

The invention relates generally to the promotion of services and products. More specifically, the invention relates to systems, methods and computer program products for promoting services and products.

### BACKGROUND

Conventional approaches for promoting services and products, such as those approaches taken by retail organizations using print, electronic, multimedia, etc., based promotions are ineffective at enhancing the sales of goods as desired.

### BRIEF DESCRIPTION OF THE INVENTION

Promotion systems and related methods are disclosed. In one embodiment, a system includes: at least one computing device configured to manage a promotion for an organization by performing actions including: providing the promotion to a user, the promotion including: an enticement to purchase a product or a service at a local location of the organization; and a unique identifier for the user and the promotion; tracking whether the user utilizes the promotion to purchase the product or the service at the local location; and providing data about the purchase of the product or the service to the organization in response to the user executing the purchase, the data about the purchase of the product including data about the promotion, data about the user, and data about the local location.

A first aspect includes a system having: at least one computing device configured to manage a promotion for an organization by performing actions including: providing the promotion to a user, the promotion including: an enticement to purchase a product or a service at a local location of the organization; and a unique identifier for the user and the promotion; tracking whether the user utilizes the promotion to purchase the product or the service at the local location; and providing data about the purchase of the product or the service to the organization in response to the user executing the purchase, the data about the purchase of the product including data about the promotion, data about the user, and data about the local location.

A second aspect includes a computer program product including program code stored on a computer readable storage medium, which when executed by at least one computing device, causes the at least one computing device to manage a promotion for an organization by performing actions including: providing the promotion to a user, the promotion including: an enticement to purchase a product or a service at a local location of the organization; and a unique identifier for the user and the promotion; tracking whether the user utilizes the promotion to purchase the product or the service at the local location; and providing data about the purchase of the product or the service to the organization in response to the user executing the purchase, the data about the purchase of the product including data about the promotion, data about the user, and data about the local location.

A third aspect includes a computer implemented method of managing a promotion for an organization, the method comprising: providing the promotion to a user, the promotion including: an enticement to purchase a product or a service at a local location of the organization; and a unique identifier for the user and the promotion; tracking whether the user utilizes the promotion to purchase the product or the service at the local location; and providing data about the purchase of the product or the service to the organization in response to the user executing the purchase, the data about the purchase of the product including data about the promotion, data about the user, and data about the local location.

### BRIEF SUMMARY OF THE DRAWINGS

FIG. 1 illustrates a promotion management system in an illustrative environment according to various embodiments of the invention.

FIG. 2 illustrates a flow diagram including a method according to various embodiments of the invention.

The drawings may only depict illustrative aspects of the invention, and are not intended to be limiting of the various embodiments herein.

### DETAILED DESCRIPTION OF THE INVENTION

As noted herein, the invention relates generally to the promotion of services and products. More specifically, the invention relates to systems, methods and computer program products for promoting services and products.

Various particular aspects include a system having: at least one computing device configured to manage a promotion for an organization by performing actions including: providing the promotion to a user, the promotion including: an enticement to purchase a product or a service at a local location of the organization; and a unique identifier for the user and the promotion; tracking whether the user utilizes the promotion to purchase the product or the service at the local location; and providing data about the purchase of the product or the service to the organization in response to the user executing the purchase, the data about the purchase of the product including data about the promotion, data about the user, and data about the local location.

Various additional particular aspects include a computer program product including program code stored on a computer readable storage medium, which when executed by at least one computing device, causes the at least one computing device to manage a promotion for an organization by performing actions including: providing the promotion to a user, the promotion including: an enticement to purchase a product or a service at a local location of the organization; and a unique identifier for the user and the promotion; tracking whether the user utilizes the promotion to purchase the product or the service at the local location; and providing data about the purchase of the product or the service to the organization in response to the user executing the purchase, the data about the purchase of the product including data about the promotion, data about the user, and data about the local location.

Various other particular aspects include a computer implemented method of managing a promotion for an organization, the method comprising: providing the promotion to a user, the promotion including: an enticement to purchase a product or a service at a local location of the organization; and a unique identifier for the user and the promotion; tracking whether the user utilizes the promotion to purchase the product or the service at the local location; and providing data about the purchase of the product or the service to the organization in response to the user executing the purchase, the data about the purchase of the product including data about the promotion, data about the user, and data about the local location.

In various embodiments, the local location is one of a plurality of local locations which are linked to the organization (e.g., commonly owned by an entity that owns the organization). For example, the local location(s) can include a subsidiary of the organization.

In various embodiments, the plurality of local locations each includes a franchise or “chain” location.

In various embodiments, the providing of the promotion to the user includes providing the promotion via at least one of an email, a text message, an SMS message, a social media post, etc.

In various embodiments, the at least one computing device is further configured to determine a future promotion offer based upon the data about the purchase of the product or the service.

In various embodiments, the at least one computing device is further configured to manage a set of data about purchases made by a plurality of users at the local location.

In various embodiments, the at least one computing device is further configured to enroll the user in a promotion program for the local location prior to the providing of the promotion to the user, in response to determining the user is associated with the local location and the user elects to follow the local location.

In various embodiments, the user elects to follow the local location using a social media network, such as a website associated with the promotion system (e.g., movethatblock.com, or MTB herein).

In various embodiments, for a business such as a retail or services business having a plurality of locations (e.g., franchise locations or other “chain” locations), various aspects of the invention create localized web pages, mobile application pages, etc., for each of the plurality of locations. These localized pages can be created by a promotion management system, described according to various embodiments of the invention.

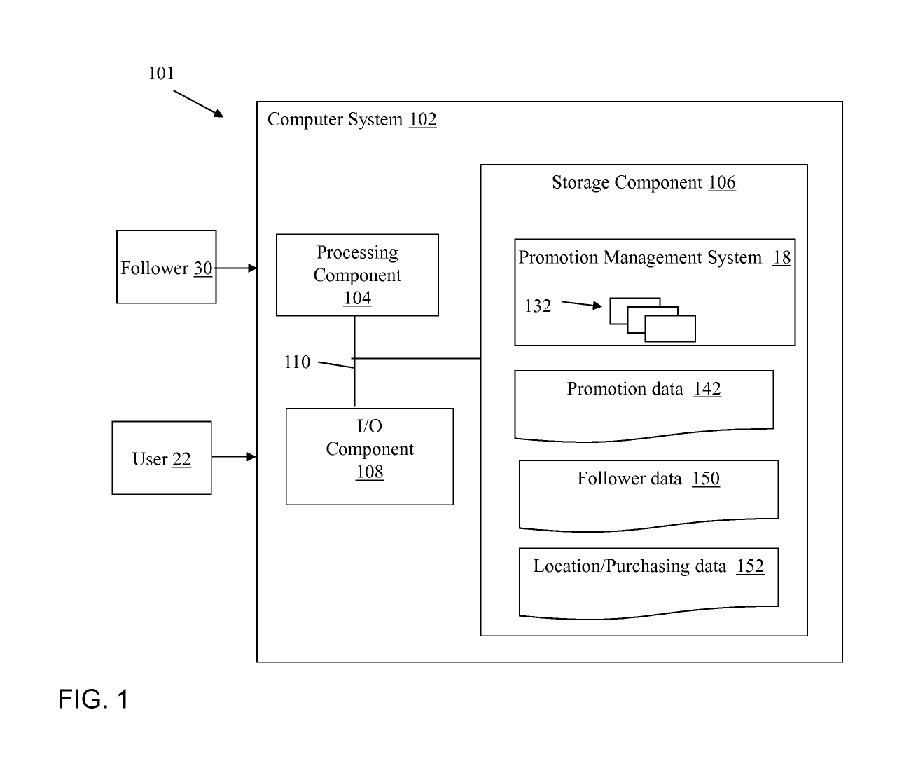

These localized web pages can be managed by the promotion management system (FIG. 1) according to the invention, and can be accessible to the business (at the local or organization-wide level).

The business can direct its customers to use the promotion management system, e.g., via a centralized web page managed by the promotion management system. The business, and in particular, the local business (e.g., franchise or chain location) can direct customers to “follow” the local business location on the promotion management system, e.g., via the web site and/or mobile site. These customers (or, “followers”) can be notified, e.g., via text message, email, SMS message, etc. of specific promotions, offers, rebates, calls to action, etc.

According to various embodiments, the promotion management system can notify all followers of the local business location with a generic message, which is sent with a unique identifier code associated with the follower's account with the promotion management system.

The unique identifier code (MTBPUI) can be derived from three pieces of data: 1) A Company Identifier (identifier of the organization such as a nation-wide organization); 2) A Location Identifier (identifier of the specific, localized company outlet such as a franchise or chain location); and 3) A Customer Identifier (unique to each follower). Examples of such a code include:

| Customer 1 | WHEELS5899785A17S54 |
|---|---|
| Customer 2 | WHEELS5899785A17S55 |
| 1 2 3 | |

1. Company Identifier: 100; 2. Promotion Identifier: 25; 3. Customer Identifier: 25863.

The customer (follower) can present the coupons/promotions and redeem those coupons/promotions at the specific location. The follower can print out the coupon/promotion, display the coupon/promotion using a mobile device, or provide his/her unique identifier code (MTBPUI) to a representative at the local business to redeem the coupon/promotion. In various embodiments, the MTBPUI can be alpha-numeric and/or include a bar code.

The coupon/promotion can be reusable in some cases, and in various embodiments, the coupon/promotion can expire after a predetermined period.

The unique identifier code (MTBPUI) can also be reusable in some cases, e.g., for multiple coupons/promotions, but in other cases, the unique identifier code is specific only to a particular promotion. Additionally, the unique identifier code (MTBPUI) can also expire after a predetermined period according to various embodiments of the invention.

In various embodiments, the promotion management system (18, FIG. 1) can be linked with the company's point-of-sale system (e.g., localized and/or remote computer systems) and can track redemption of coupons/promotions in real-time and without input by a member of the company. In this case, the point-of-sale data can be uploaded to the promotion management system substantially instantaneously after redemption of the coupon/promotion. In some cases, an employee at the point-of-sale can manually input the code(s) for uploading to the promotion management system.

Subsequently issued coupons/promotions can be based upon the previously redeemed coupons/promotions, as well as purchasing data for each follower. In some cases, the promotion management system can issue subsequent coupons/promotions based upon the brand, type of product and/or service, etc. redeemed (or simply purchased) by the follower.

In other cases, an administrator, either from the company or from the promotion management system group (the managing entity of the promotion management system) can log data about the purchases made by the follower using the MTBPUI. In some cases, the administrator can manually log data about purchases (e.g., amount spent, types of goods/services, etc.) made by the follower using the MTBPUI on a daily and/or weekly basis.

The promotion management system (18, FIG. 1) can also provide reports to the company (e.g., the larger corporate organization) about each specific location (e.g., localized franchises or chain locations) and the use of MTBPUI at each particular location. The larger corporate organization can then utilize the promotion management system to provide location-specific rewards/promotions to followers for each particular location (e.g., franchise or chain).

In various particular embodiments, the system (computer system 102, FIG. 1) can perform the following functions:

P1. Promotion management system (e.g., web-based system at MoveThatBlock.com, also called MTB herein, 18, FIG. 1) creates specific, localized page for each business location.

P2. ADMIN from MTB or Company has access to page.

P3. Company directs customers to follow individual store's page on promotion management system website (e.g., MoveThatBlock.com).

P4. Followers are emailed or texted (follower's choice) with specific promotions, offers, rebates, calls to action, etc.

P5. Every follower of a specific page/location may receive the same message with the exception of each follower's MTBPUI. In some alternative embodiments, the message (e.g., promotion, offer, rebate, etc.) can be customized and directed to each follower on an individual or sub-group basis.

P6. MTBPUI is derived from at least three parts (and in some cases one or more additional parts including a number identifier for a specific promotion): Company Identifier, Location Identifier, and Customer Identifier.

By way of example, below are two MTBPUI Codes for two different followers of the same business' location:

| | |
|---|---|
| Customer 1: | WHEELS5899785A17S54 |
| Customer 2: | WHEELS5899785A17S55 |
| A B C | |

A. Company Identifier—100; B. Promotion Identifier—25; C. Customer Identifier—25863

P7. Customer (follower) can print out coupons/promotions or give the cashier customer's unique MTBPUI.

P8. MTBPUI Codes can be set to be reusable or expire within a custom selected time frame.

P9. If linked with company point-of sale system, customer redemption and purchases are tracked automatically. The promotion management system allows subsequent emails and texts to be based on follower's preferred brands, types of products and services, etc. resulting in more targeted offers to company's customers/followers.

P10. If manual, ADMIN logs onto page at promotion management system website (e.g., MoveThatBlock.com). ADMIN inputs MTBPUI Code, amount spent, and Description and/or Item Number(s) on a daily or weekly basis.

P11. Promotion management system creates location and customer specific reports to offer unique, customer specific promotions based on tracked customer preferences and purchasing behaviors.

In further particular embodiments the promotion management system can perform the following:

P21. A follower of a Specific Location is automatically assigned a specific and unique referral tracking ID.

P22. Followers can email or text that unique referral code to friends with similar interests (e.g., via social media or direct contact using email or text).

P23. Promotion management system website (e.g., MoveThatBlock.com) also interacts with social media sites like Facebook.com to control the specific message attached to that follower's post. In some cases, the promotion management system can control the post attachment by providing a post message to the follower's message board, e.g., alongside (in the same feed) as a follower's post.

P24. Promotion management system (18, FIG. 1) can track that unique code and can automatically email/text reward coupons, codes, discounts, or promotions based on redemption rates and conversion rates selected by company (e.g., corporate entity, not specific location or franchise/chain).

Various embodiments of the invention may provide the following benefits:

A) Increase sales from positive online reviews.

B) Easily connect with customers.

C) Stores can direct customers to write reviews, comment, and follow them on promotion management system website (e.g., MoveThatBlock.com).

D) Customers will be able to unfollow individual stores that abuse the marketing system or fail to offer their customers offers of interest by a simple click of the button (the ability to easily unfollow tends to make users more likely to follow an individual store).

E) Managers can quickly resolve unsatisfied customers issues by responding to their complaints through email, text, or promotion management system website (e.g., MoveThatBlock.com) message inbox in real time.

F) From store managers to home office, company (e.g., corporate entity) decides which & how many company representatives receive real time text alerts or emails from customers.

G) At company's direction, promotion management system website (e.g., MoveThatBlock.com) will send store specific promotions to company followers of each individual store by email or text.

H) Group monitoring functionality: If one store representative responds to a review or comment, company can choose who in the group of followers will be copied on the email/text exchange and who is copied on exchange communications.

I) Better understand followers'/customers' needs and wants.

J) Reviews, ratings, and comments will give stores a better understanding of how customers feel about company's products and services in customers' own words. Specific stores can ask their customers specific questions if they choose.

K) Receive monthly analytics reporting to measure effectiveness of listing on promotion management system website (e.g., MoveThatBlock.com).

L) Monthly reports will report on the effectiveness of the targeted promotion management system

M) Integrate into your store's CRM or Loyalty programs.

In various other embodiments, the promotion management system can provide the following:
Price discount for multiple store locations
Promotion management system creates and maintains business listing page (includes: new product promotions, weekly flyers, printable coupons, nutritional information, menus, store facts, pictures, video uploads, etc.).
Promotion management system provides email or text alerts from customers
Company determines who receives the messages (examples: Store Manager, District Manager, Shift Supervisor, Corporate Office, etc.)
Company decides how and when the promotion management system contacts stores on an individual store basis in order to discuss promotion, email/text blasts, etc.
Search Engine Optimization services to capture keywords relevant to company's business to bring potential customers to company's business listing page on promotion management system website (e.g., MoveThatBlock.com).

Various other benefits can be realized through use of the promotion management system (and associated website):
Allows companies to directly communicate with their customers and market to them on a localized, store by store basis.
Allows companies to up sell and cross sell based on customers' individual shopping patterns and habits.
Allows companies to track customer purchases in discreet, yet non-intrusive way.
Allows company to refine offerings based on customer response and redemption rates through MTBPUI which customizes each promotion automatically indicating company, location, and customer.
Customers can print out coupon for scanning or provide company with one alpha numeric code that identifies both the promotion and the specific customer redeeming the offer at the point of sale/purchase.
Eliminates customers having to carry multiple reward cards for every kind of store on their key chains or in their wallets.
Allows customers to redeem coupons, points, or receive incentives for telling people about the company. They can do this easily through email, text, or on social media sites like Facebook by forwarding an automatically generated, unique referral code for each business and customer. This is beneficial for offers like buy one, get one deals or group deals.
Company pays flat, annual rate plus cost of printed promotional materials.
Save on cost of direct mail, weekly flyers, newspaper inserts, etc.
Automatically track what people (followers/customers) are saying about the company or locations online with the “You Know First Program”. This is an internet monitoring service that notifies the company by text or email any time someone mentions the company online.
Customers can purchase and redeem online gift cards/codes.

In various other embodiments, the promotion management system 18 (e.g., via the MTB website), can provide the following:

1) MTB creates a specific, localized page for each individual store on the website (MTB.com).

2) Each individual store (franchise, chain, etc.) encourages customers to follow that specific store on the website (e.g., MTB.com) through in store signage, etc.

3) A customer goes to that specific webpage (via MTB.com) and clicks a “Follow” button. The customer can choose to follow that specific store (franchise, chain, etc.) by providing either his/her email address or cell phone number so that the follower can receive either email promotions or text messages.

4) A store follower (customer) can rate that specific store, write a review, or praise/complain through that specific store's individual page. The group functionality allows an unlimited number of company employees (store level, district level, or corporate) to be copied on communications. The company employees choose to receive messages (e.g., email or text message) with the complaint, review, or praise in real-time. If one person responds, everyone on that list for that store (franchise, chain, etc.) at the company can be copied on the response. The promotion management system thus gives the ability of the company (via employees) to respond in real time while the customer is still in the store.

5) The promotion management system also offers alpha numeric codes or bar codes (depending on company's POS software) that track specific email/text promotions and unique codes for each individual store customer. When a customer redeems the promotion, the promotion management system can track purchases and respond so each subsequent offer can be based on customer's unique purchasing habits.

6) The promotion management system allows the company to up-sell and cross-sell to its customers by tracking purchasing habits in a non-intrusive way.

7) The promotion management system also offers unique, tell-your-friends redemption codes that can be automatically posted to a customer's social media page or emailed, sent via text message, etc. It allows existing customers to send a group-buy to their friends to use in a specific store. The company can determine how many people need to click on the link and accept the group deal. If that number is reached, everyone that signed up can be either sent an email or a text with that unique promotional code that they can redeem in store.

It is understood that in various alternative embodiments, the promotion management system(s) described herein can be utilized as more general notification systems. For example, in some cases, the notification system can utilize the functions described herein to provide emergency notifications, alerts, or other notifications to a particular group. In various embodiments, a plurality of followers such as residents of a municipality (town, county, etc.), students/faculty/staff associated with an educational institution, employees and affiliates of an employer, etc. could sign-up (follow) with the notification system to receive notifications relating to their particular group. For example, in the case of an emergency such as a power outage, criminal activity, natural disaster, or even non-emergency events such as a school delay or limitation on accessibility (e.g., elevator and/or doors out of order), the notification system could send a notification to one or more followers. In some cases, as described herein, the notification system could notify only a sub-set of the followers based upon particular settings (e.g., position in the group). In any case, it is understood that various embodiments of the invention provide for notification of followers in various groups.

FIG. 1 depicts an illustrative environment 101 for managing promotional activities according to embodiments. To this extent, the environment 101 includes a computer system 102 that can perform a process described herein in order to manage promotional activities. In particular, the computer system 102 is shown as including a promotion management system 18, which makes computer system 102 operable to manage promotional activities by performing any/all of the processes described herein and implementing any/all of the embodiments described herein.

In various embodiments of the invention, the computer system 102 communicates with a user 22 and/or a follower 30 to perform various aspects of the invention. It is understood that the computer system 102 can communicate with the user 22 and/or the follower 30 via any conventional mechanisms, e.g., wirelessly, via a user interface, via one or more portable devices such as a mobile phone, tablet computer, laptop, etc.

The computer system 102 is shown including a processing component 104 (e.g., one or more processors), a storage component 106 (e.g., a storage hierarchy), an input/output (I/O) component 108 (e.g., one or more I/O interfaces and/or devices), and a communications pathway 110. In general, the processing component 104 executes program code, such as the promotion management system 18, which is at least partially fixed in the storage component 106. While executing program code, the processing component 104 can process data, which can result in reading and/or writing transformed data from/to the storage component 106 and/or the I/O component 108 for further processing. The pathway 110 provides a communications link between each of the components in the computer system 102. The I/O component 108 can comprise one or more human I/O devices, which enable a human user 22 (e.g., Administrator) to interact with the computer system 102 and/or one or more communications devices to enable a system user 22 to communicate with the computer system 102 using any type of communications link. To this extent, the promotion management system 18 can manage a set of interfaces (e.g., graphical user interface(s), application program interface, etc.) that enable human and/or system users 22 to interact with the promotion management system 18. Further, the promotion management system 18 can manage (e.g., store, retrieve, create, manipulate, organize, present, etc.) data, such as promotion data (including types of promotions, past promotions, upcoming promotions, etc.) 142, follower data (including data about followers, e.g., demographic data, preferences, purchasing trends, etc.) 150 and/or location/purchasing data (including data about the purchase locations, items purchased, whether particular promotions were used in conjunction with a purchase, etc.) 152 using any solution.

In any event, the computer system 102 can comprise one or more general purpose computing articles of manufacture (e.g., computing devices) capable of executing program code, such as the promotion management system 18, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, the promotion management system 18 can be embodied as any combination of system software and/or application software.

Further, the promotion management system 18 can be implemented using a set of modules 132. In this case, a module 132 can enable the computer system 102 to perform a set of tasks used by the promotion management system 18, and can be separately developed and/or implemented apart from other portions of the promotion management system 18. As used herein, the term “component” means any configuration of hardware, with or without software, which implements the functionality described in conjunction therewith using any solution, while the term “module” means program code that enables the computer system 102 to implement the functionality described in conjunction therewith using any solution. When fixed in a storage component 106 of a computer system 102 that includes a processing component 104, a module is a substantial portion of a component that implements the functionality. Regardless, it is understood that two or more components, modules, and/or systems may share some/all of their respective hardware and/or software. Further, it is understood that some of the functionality discussed herein may not be implemented or additional functionality may be included as part of the computer system 102.

When the computer system 102 comprises multiple computing devices, each computing device may have only a portion of promotion management system 18 fixed thereon (e.g., one or more modules 132). However, it is understood that the computer system 102 and promotion management system 18 are only representative of various possible equivalent computer systems that may perform a process described herein. To this extent, in other embodiments, the functionality provided by the computer system 102 and promotion management system 18 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 102 includes multiple computing devices, the computing devices can communicate over any type of communications link. Further, while performing a process described herein, the computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

The computer system 102 can obtain or provide data, such as promotion data 142, follower data 150 and/or location/purchasing data 152 using any solution. For example, the computer system 102 can generate and/or be used to retrieve promotion data 142, follower data 150 and/or location/purchasing data 152, from one or more data stores, receive promotion data 142, follower data 150 and/or location/purchasing data 152, from another system, send promotion data 142, follower data 150 and/or location/purchasing data 152 to another system, etc.

In other embodiments, the computer system 102 can generate promotion data 142, follower data 150 and/or location/purchasing data 152 and/or be used to retrieve promotion data 142, follower data 150 and/or location/purchasing data 152 from one or more data stores, receive promotion data 142, follower data 150 and/or location/purchasing data 152, from another system, send promotion data 142, follower data 150 and/or location/purchasing data 152 to another system, etc. In various embodiments, the computer system 102 can generate promotion data 142, follower data 150 and/or location/purchasing data 152 and/or be used to retrieve promotion data 142, follower data 150 and/or location/purchasing data 152 from one or more data stores, receive promotion data 142, follower data 150 and/or location/purchasing data 152 from another system, send promotion data 142, follower data 150 and/or location/purchasing data 152 to another system, etc.

While shown and described herein as a method and system for managing promotions, it is understood that aspects of the invention further provide various alternative embodiments. For example, in one embodiment, the invention provides a computer program fixed in at least one computer-readable medium, which when executed, enables a computer system to manage promotions according to various embodiments of the invention. To this extent, the computer-readable medium includes program code, such as the promotion management system 18 (FIG. 1), which implements some or all of the processes and/or embodiments described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; etc.

In another embodiment, the invention provides a method of providing a copy of program code, such as the promotion management system 18 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for managing promotions. In this case, a computer system, such as the computer system 102 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; etc.

As noted herein, in various embodiments, promotion systems and related methods are disclosed. In one embodiment, a system includes: at least one computing device configured to manage a promotion for an organization by performing actions including: providing the promotion to a user, the promotion including: an enticement to purchase a product or a service at a local location of the organization; and a unique identifier for the user and the promotion; tracking whether the user utilizes the promotion to purchase the product or the service at the local location; and providing data about the purchase of the product or the service to the organization in response to the user executing the purchase, the data about the purchase of the product including data about the promotion, data about the user, and data about the local location.

In various embodiments, the local location is one of a plurality of local locations belonging to the organization.

In various embodiments, the plurality of local locations each includes a franchise or chain location.

In various embodiments, the providing of the promotion to the user includes providing the promotion via at least one of an email, a text message or an SMS message.

In various embodiments, the at least one computing device is further configured to determine a future promotion offer based upon the data about the purchase of the product or the service.

In various embodiments, the at least one computing device is further configured to manage a set of data about purchases made by a plurality of users at the local location.

In various embodiments, the at least one computing device is further configured to enroll the user in a promotion program for the local location prior to the providing of the promotion to the user, in response to determining the user is associated with the local location and the user elects to follow the local location.

In various embodiments, the user elects to follow the local location using a social media network.

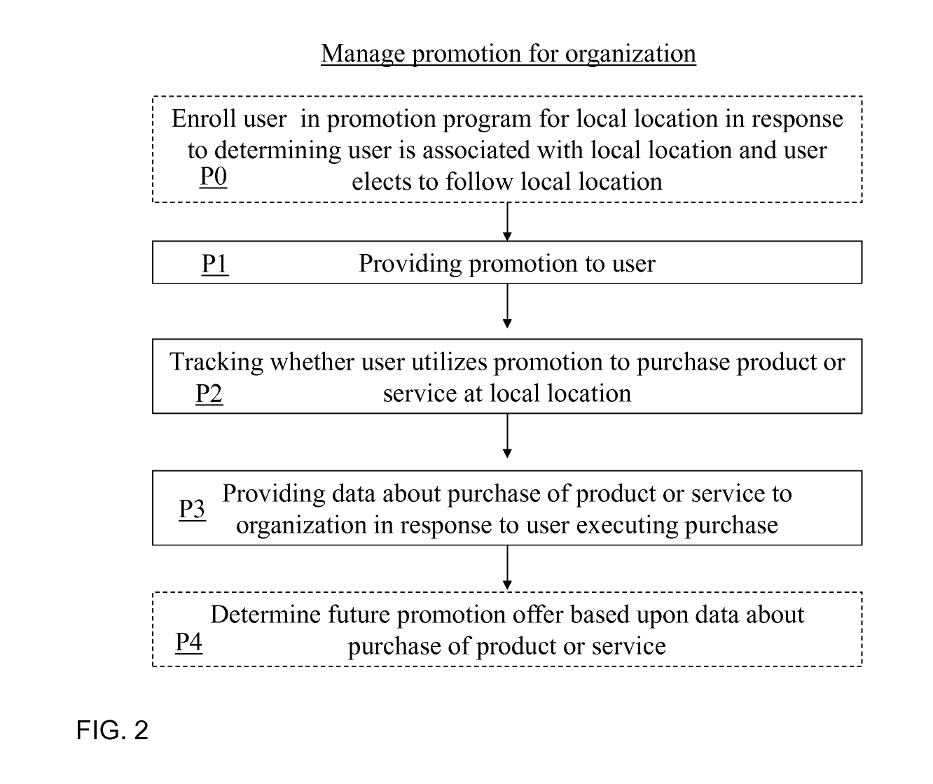

FIG. 2 shows an illustrative method of managing promotion(s) for an organization, performed according to various embodiments of the invention. The method can be performed utilizing at least one computing device, e.g., via a computer-implemented method, execution of a computer program product including program code for performing the method, and/or via a computing device configured to perform the method. As shown, the method can include:

Process P0 (optional pre-process): Enrolling a user in a promotion program for a local location (prior to providing promotion to the user), in response to determining the user is associated with the local location and the user elects to follow the local location. As described herein, the local location can include one of a plurality of local locations belonging to the organization (e.g., franchise location(s) and/or chain location(s)). In various embodiments, the user can elect to follow the local location using a social media network.

Process P1: Providing the promotion to the user. As described herein, providing the promotion to the user can include providing the promotion via at least one of an email, a text message or an SMS message.

Process P2: tracking whether the user utilizes the promotion to purchase the product or the service at the local location. In various embodiments, the promotion further includes a promotion-specific link that is sharable with or transferrable to a distinct user. In the case of a sharable promotion-specific link, the user and the distinct user can both utilize the promotion-specific link during the open period of redemption. In the case of a transferrable promotion-specific link the user can transfer the promotion for use by the distinct user during the open period of redemption, without redeeming it himself/herself. In various embodiments, the user and the distinct user form a group, each member of which obtains a group offer by using the promotion-specific link to purchase the product. In yet other embodiments, the promotion-specific link is sharable with or transferrable to a further distinct user, the further distinct user joining the group upon using the promotion-specific link to purchase the product.

Process P3: providing data about the purchase of the product or the service to the organization in response to the user executing the purchase. The data about the purchase of the product can include data about the promotion, data about the user, and data about the local location.

Process P4 (optional post-process): determine a future promotion offer based upon the data about the purchase of the product or the service.

In various additional embodiments, the process can also include managing a set of data about purchases made by a plurality of users (aside from or in addition to the user, distinct user, etc.) at the local location.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system comprising:
at least one computing device configured to manage a promotion for an organization by performing actions including:
providing the promotion to a user, the promotion including:
an enticement to purchase a product or a service at a local location of the organization; and
a unique identifier for the user and the promotion;
tracking whether the user utilizes the promotion to purchase the product or the service at the local location; and
providing data about the purchase of the product or the service to the organization in response to the user executing the purchase, the data about the purchase of the product including data about the promotion, data about the user, and data about the local location.

2. The system of claim 1, wherein the local location is one of a plurality of local locations belonging to the organization.

3. The system of claim 2, wherein the plurality of local locations each include a franchise or a chain location.

4. The system of claim 1, wherein the providing of the promotion to the user includes providing the promotion via at least one of an email, a text message or an SMS message.

5. The system of claim 1, wherein the at least one computing device is further configured to determine a future promotion offer based upon the data about the purchase of the product or the service.

6. The system of claim 1, wherein the at least one computing device is further configured to manage a set of data about purchases made by a plurality of users at the local location.

7. The system of claim 1, wherein the at least one computing device is further configured to enroll the user in a promotion program for the local location prior to the providing of the promotion to the user, in response to determining the user is associated with the local location and the user elects to follow the local location.

8. The system of claim 7, wherein the user elects to follow the local location using a social media network.

9. The system of claim 1, wherein the promotion further includes a promotion-specific link that is sharable with or transferrable to a distinct user, wherein the user and the distinct user form a group, each member of which obtains a group offer by using the promotion-specific link to purchase the product.

10. The system of claim 9, wherein the promotion-specific link is sharable with or transferrable to a further distinct user, the further distinct user joining the group upon using the promotion-specific link to purchase the product.

11. A computer program product comprising program code stored on a computer readable storage medium, which when executed by at least one computing device, causes the at least one computing device to manage a promotion for an organization by performing actions including:
providing the promotion to a user, the promotion including:
an enticement to purchase a product or a service at a local location of the organization; and
a unique identifier for the user and the promotion;
tracking whether the user utilizes the promotion to purchase the product or the service at the local location; and
providing data about the purchase of the product or the service to the organization in response to the user executing the purchase, the data about the purchase of the product including data about the promotion, data about the user, and data about the local location.

12. The computer program product of claim 11, wherein the local location is one of a plurality of local locations belonging to the organization, wherein the plurality of local locations each include a franchise or a chain location.

13. The computer program product of claim 11, wherein the providing of the promotion to the user includes providing the promotion via at least one of an email, a text message or an SMS message.

14. The computer program product of claim 11, wherein the program code causes the at least one computing device to determine a future promotion offer based upon the data about the purchase of the product or the service.

15. The computer program product of claim 11, wherein the program code causes the at least one computing device to manage a set of data about purchases made by a plurality of users at the local location.

16. The computer program product of claim 11, wherein the program code causes the at least one computing device to enroll the user in a promotion program for the local location prior to the providing of the promotion to the user, in response to determining the user is associated with the local location and the user elects to follow the local location.

17. The computer program product of claim 16, wherein the user elects to follow the local location using a social media network.

18. The computer program product of claim 11, wherein the promotion further includes a promotion-specific link that is sharable with or transferrable to a distinct user, wherein the user and the distinct user form a group, each member of which obtains a group offer by using the promotion-specific link to purchase the product.

19. The computer program product of claim 18, wherein the promotion-specific link is sharable with or transferrable to a further distinct user, the further distinct user joining the group upon using the promotion-specific link to purchase the product.

20. A computer implemented method of managing a promotion for an organization, the method comprising:
providing the promotion to a user, the promotion including:
an enticement to purchase a product or a service at a local location of the organization; and
a unique identifier for the user and the promotion;
tracking whether the user utilizes the promotion to purchase the product or the service at the local location; and
providing data about the purchase of the product or the service to the organization in response to the user executing the purchase, the data about the purchase of the product including data about the promotion, data about the user, and data about the local location.
